(19) United States
(12) Patent Application Publication
(10) Pub. No.: US 2009/0015003 A1
(43) Pub. Date: Jan. 15, 2009

(54) Sanitary Fitting Comprising A Connecting Device Which Is Used To Connect A Water Outlet Housing To A Functional Component

(75) Inventor: Lars Schmid, Nuertingen (DE)

Correspondence Address: FACTOR & LAKE, LTD, 1327 W. WASHINGTON BLVD., SUITE 5G/H, CHICAGO, IL, 60607, US

(73) Assignee: HANSA METALLWERKE AG, Stuttgart (DE)

(21) Appl. No.: 11/814,431

(22) PCT Filed: Jan. 20, 2006
(86) PCT No.: PCT/EP2006/000500

§ 371 Date: Apr. 16, 2008

(30) Foreign Application Priority Data
Jan. 22, 2005 (DE) 10 2005 003 051.3

(51) Int. Cl. F16L 19/02

(52) U.S. Cl. 285/8

(57) ABSTRACT

The invention relates to a sanitary fitting (1), in particular, a washstand fitting, comprising a connecting device (7) which is used to connect a water outlet housing (2) to a functional component (4), in particular a valve block. Said connecting device (7) comprises a clamping device (10, 11, 12, 15) which enables the functional component (4) to be temporarily fixed to the water outlet housing (2) by means of relative displacement, and a tensioning device (19, 20, 21) which enables the functional component (4) to be connected in a stable manner to the water outlet housing (2).

The invention relates to a sanitary fitting, in particular a washbasin fitting, comprising a connecting device which is used to connect a water outlet housing to a functional component.

In the case of known sanitary fittings, a water outlet housing with a plug-in connecting piece is plugged from above, for example, into an opening of a washbasin. The functional component, for example a valve block and a mixing block fastened thereto, is fastened from below to the plug-in connecting piece. The fitter usually requires both hands to hold the functional component, since the functional component is often very heavy and unwieldy and is relatively large in relation to the installation space. Moreover, the region below the washbasin is often difficult to get at. The fitter, however, then no longer has a hand free for the fastening, adjusting and screwing.

The object of the present invention is to design a sanitary fitting of the type mentioned at the outset in such a way that quick and technically simple mounting is made possible.

This object is achieved according to the invention in that the connecting device has a clamping device, by which the functional component can be temporarily fixed to the water outlet housing by a relative movement, and a tensioning device, by which the functional component can be stably connected to the water outlet housing.

According to the invention, a clamping device is therefore provided, by which the functional component can be prefixed to the water outlet housing by a single action, so that the fitter has both hands free for the subsequent fastening, adjusting and screwing. The water outlet housing and the functional component can subsequently be braced against one another by the tensioning device. Thus, functional components which are heavy and bulky in relation to the installation space or complicated functional components can also be mounted quickly and simple with a small number of actions.

In a particularly advantageous embodiment, the clamping device comprises the following cooperating components:
a) at least one clamping spring;
b) a first groove, adapted to the clamping spring, in a first component, in particular a flange groove in a spring flange connected to the functional component;
c) a second groove, adapted to the clamping spring and facing the first groove, in a second component displaceable relative to the first component, in particular a housing groove in the water outlet housing.

A clamping spring and grooves are technically particularly simple to produce and are robust.

In order to be able to brace the prefixed components to one another simply and without a high level of technical outlay, the tensioning device comprises at least one connecting screw and a corresponding thread, by which screw and thread the first component, in particular the spring flange, is tensibly connected to the functional component.

Markedly quicker mounting is made possible if a thread spring is provided for receiving the connecting screw, into which the connecting screw can be quickly inserted without screwing. For bracing, the connecting screw can subsequently be tightened.

In order to prevent the connecting device from slipping off from the water outlet housing, in particular under high tensile loads caused by heavy functional components, the clamping device can have an in particular progressive self-locking device, in particular at least one guide slope for the clamping spring, in particular for at least one guide pin of the clamping spring, whereby the clamping action of the clamping device is improved when the latter is subjected to increasing tension.

Advantageously, the connecting device has at least one fixing device for fixing the angular position of the functional component relative to the water outlet housing, in particular a fixing pin and a fixing-pin receptacle cooperating with the latter. In this way, it is ensured that the functional component rests in the correct position against the water outlet housing.

The water outlet housing can be sealed off with respect to the functional component by a moulded seal.

It is particularly advantageous if the functional component comprises a valve block and/or a mixing block. Valve blocks and mixing blocks fastened thereto are heavy and unwieldy components which can be connected particularly simply to the water outlet housing by the connecting device.

An exemplary embodiment of the invention is explained in more detail below with reference to the drawing, in which

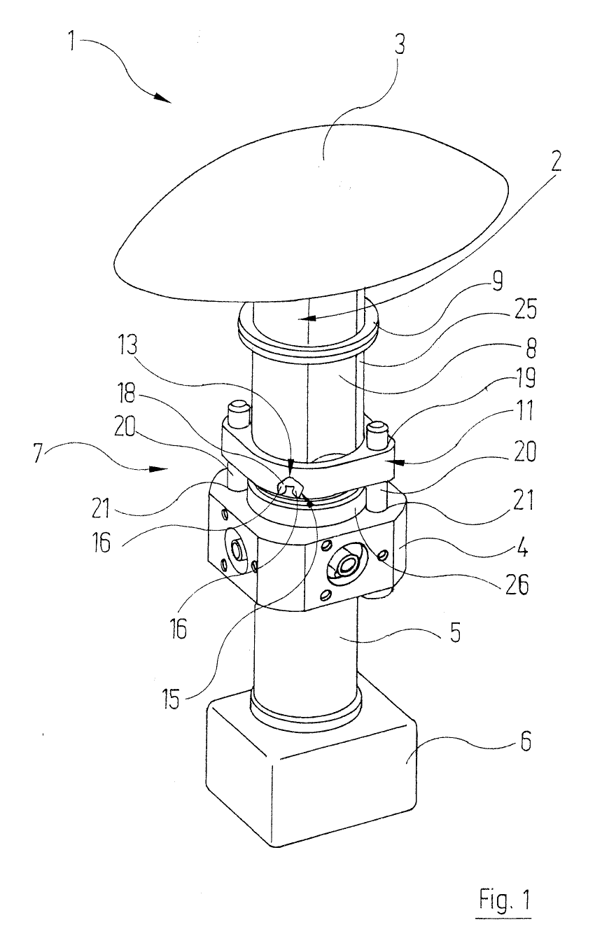

FIG. 1 schematically shows a perspective illustration of a sanitary fitting, in which a water outlet housing is connected to a valve block via a spring flange;

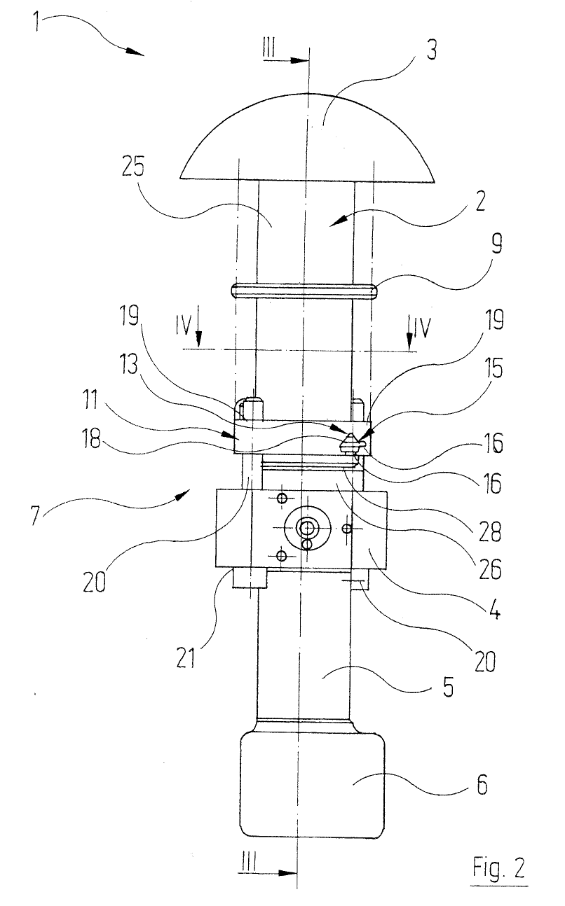

FIG. 2 schematically shows a left side view of the sanitary fitting illustrated in FIG. 1;

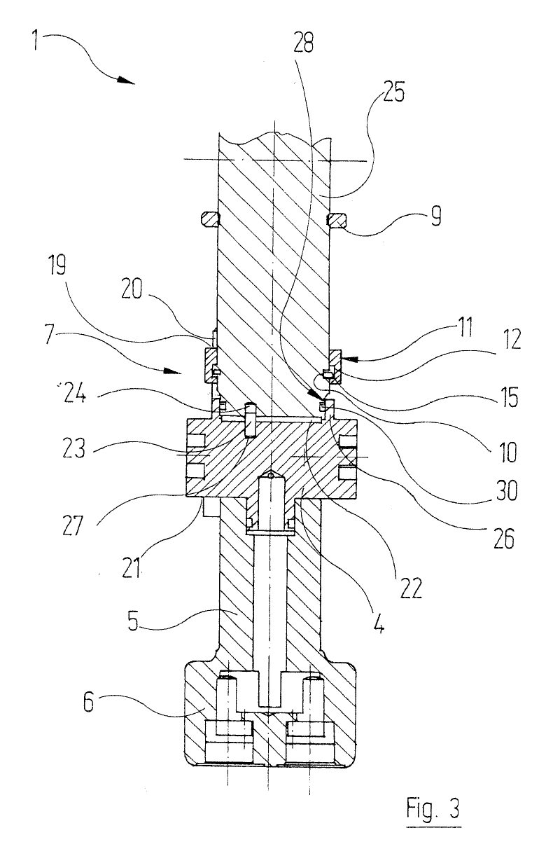

FIG. 3 schematically shows a longitudinal section of the sanitary fitting illustrated in FIG. 2 along the line III-III therein, with the housing upper part cut off;

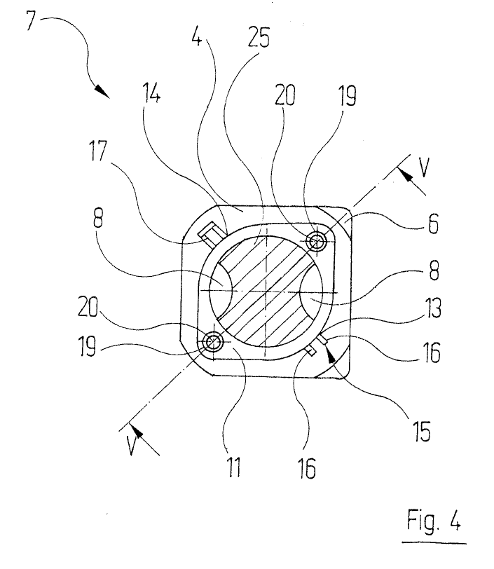

FIG. 4 schematically shows a cross-section of the sanitary fitting illustrated in FIG. 2 in a region above the spring flange along the line IV-IV therein;

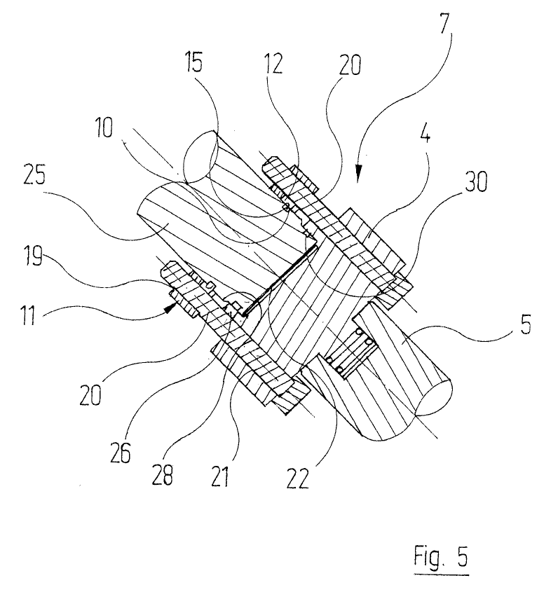

FIG. 5 schematically shows a longitudinal section of the sanitary fitting illustrated in FIG. 2 in the region of the spring flange along the line V-V in FIG. 5.

Illustrated in FIG. 1 is a sanitary fitting, provided as a whole with the reference symbol 1, for a washbasin (not shown).

The sanitary fitting 1 comprises, at the top in FIG. 1, a water outlet housing 2 having a housing upper part 3, illustrated in a stylised manner, and a plug-in connecting piece 25, and, at the bottom, a known valve block 4 which is screwed to a likewise known mixing block 6 via a customary block connection 5. Cold and hot water are supplied in a specific mixing ratio to the mixing block 6. Situated in the valve block 4 is an electrically actuable valve which controls the water flow to the outlet in the housing upper part 3.

The plug-in connecting piece 25 is connected to the valve block 4 by a connecting device 7.

The plug-in connecting piece 25 has a substantially circular cross-section (FIG. 4). In its lateral surface, two identical housing recesses 8 run axially, mirror-invertedly opposite one another, over the entire length of the plug-in connecting piece 25, each having a constant circular-segment-shaped cross-section.

At its lower end, illustrated in longitudinal section in FIG. 3, the plug-in connecting piece 25 has a diminution 28 with a circumferential annular groove 30 containing an O-ring.

A retaining nut 9 can be screwed onto an external thread of the lateral surface of the plug-in connecting piece 25.

The water outlet housing 2 is plugged from above into an opening of the washbasin (not illustrated), the housing upper part 3 being arranged above the on the washbasin. The remaining components of the sanitary fitting 1 are situated below the washbasin. The water outlet housing 2 is fixed from below to the washbasin by the retaining nut 9.

Furthermore, the plug-in connecting piece 25 has in its outer lateral surface, somewhat above the diminution 28, a circumferential housing groove 10 (FIG. 3).

At the height of the housing groove 10, a hollow-cylindrical spring flange 11 as part of the connecting device 7 is arranged coaxially on the lateral surface of the plug-in connecting piece 25. The spring flange 11 has an ellipse-like outer cross-section and a circular inner cross-section (FIG. 4), so that two opposite wall thickenings are produced. The inner cross-section of the spring flange 11 corresponds to the outer cross-section of the plug-in connecting piece 25.

Arranged in each of the wall thickenings is a threaded through-bore 19, the axes of these bores running parallel to the axis of the spring flange 11.

Along its inner lateral surface, there is arranged in the spring flange 11, opposite the housing groove 10, a circumferential flange groove 12. The flange groove 12 is approximately twice as wide, in the axial direction of the spring flange 11, as the housing groove 10 (FIG. 3).

Furthermore, the spring flange 11 has in the bottom of the flange groove 12 a radially running clamping-spring-pin through-opening 13 (FIG. 1) and on the opposite side, likewise in the bottom of the flange groove 12, a radially running clamping-spring-projection through-opening 14 (FIG. 4).

Situated in the space formed by the housing groove 10 and the flange groove 12 is a slotted, ring-shaped clamping spring 15 with a round profile (FIG. 3).

The diameter of the clamping spring 15 in its relaxed state is smaller than the outside diameter of the plug-in connecting piece 25, so that it is tensioned in the housing groove 10. The profile diameter of the clamping spring 15 is approximately twice as large as the depth of the housing groove 10 in the radial direction of the plug-in connecting piece 25, so that the outer profile half of the clamping spring 15 projects beyond the edge of the housing groove 10 into the flange groove 12. This prevents the spring flange 11 from being able to slip upwards or downwards, in FIGS. 1, 2, 3, relative to the plug-in connecting piece 25. The clamping spring 15, the housing groove 10 and the flange groove 11 thus act as a clamping device.

In addition, the profile diameter of the clamping spring 15 is somewhat smaller than the depth of the flange groove 12 in the radial direction of the spring flange 11, so that the clamping spring 15, provided it is bent up radially outwards, can be sunk fully into the flange groove 12 and the spring flange 11 can be removed from the plug-in connecting piece 25.

The two ends of the clamping spring 15 project outwards approximately in the radial direction of the spring flange 11 and thus form two guide pins 16 (FIG. 4).

On the opposite side of the guide pins 16, the clamping spring 15 has a clamping-spring projection 17, which is square in FIG. 4. The clamping-spring projection 17 is formed from two parallel regions of the clamping spring 15 which are bent outwards substantially in the radial direction of the spring flange 11 and the radially outer ends of which are connected in one piece to one another.

The guide pins 16 project through the clamping-spring-pin opening 13 and the clamping-spring projection 17 projects, through the clamping-spring-projection opening 14, beyond the outer lateral surface of the spring flange 11, so that the clamping spring 15 is retained in the flange groove 12.

The guide pins 16 can be pushed apart from outside the spring flange 11, in order to increase the diameter of the clamping spring 15 and thus sink the latter into the flange groove 12.

The cross-section of the clamping-spring-pin opening 13 has the shape of a triangle, the vertex of which points upwards (FIG. 1, 2). The two upper side faces of the clamping-spring-pin opening 13 each form a guide slope 18 for the corresponding guide pin 16 of the clamping spring 15. If the clamping spring 15 is displaced upwards, in FIGS. 1, 2, relative to the spring flange 11, the guide pins 16 are guided along the guide slopes 18 and moved towards one another, so that the diameter of the clamping spring 15 is increasingly reduced and the clamping spring 15 is pressed into the housing groove 10. This is the case if the spring flange 11 is pulled downwards, in FIGS. 1, 2, 3, relative to the water outlet housing 2. In this way, on being pulled downwards, progressive self-locking of the spring flange 11 on the plug-in connecting piece 25 is produced.

The clamping-spring-pin opening 13 has in its bottom face an opening to the lower end side of the spring flange 11. On introducing the clamping spring 15 into the housing groove 10 at the factory, the guide pins 16 are guided through this opening into the clamping-spring-pin opening 13.

Situated in each of the threaded bores 19 of the spring flange 11 is a connecting screw 20, preferably a hexagon socket screw, by which screws the spring flange 11 is screwed to the valve block 4.

Provided in the valve block 4 are two through-bores 21 for the connecting screws 20, the axes of which run coaxially with the axes of the threaded bores 19. The heads of the connecting screws 20 are positioned below the valve block 4 in FIGS. 1, 2, 3. A tensioning device is produced by the connecting screws 20, the threaded bores 19 and the through-bores 21.

The valve block 4 has substantially the shape of a cuboid. Protruding from its upper end side in FIG. 3 is a hollow-cylindrical socket 26, into which the diminution 28 of the water outlet housing 2 is plugged. The inside diameter of the socket 26 corresponds to the outside diameter of the diminution 28 of the plug-in connecting piece 25. The diminution 28 is sealed off with respect to the socket 26 by the O-ring in the ring groove 30.

A moulded seal 22 is provided between the upper plane end side of the valve block 4, within the socket 26, and the lower plane end side of the plug-in connecting piece 25.

Furthermore, the upper end side of the valve block 4 has, in a region within the socket 26 outside the centre thereof, a bore 27 for a fixing pin 23.

A fixing-pin receptacle 24, complementary to the fixing pin 23, is provided in the lower end side of the plug-in connecting piece 25.

The angular position of the valve block 4 with respect to the plug-in connecting piece 25 is fixed by the fixing pin 23 in the fixing-pin receptacle 24.

In order to mount the sanitary fitting 1 on the washbasin, first of all the plug-in connecting piece 25 is inserted from above through the opening of the washbasin until the lower side of the housing upper part 3 rests on the upper side of the washbasin.

Thereafter, the water outlet housing 2 is clamped from below against the lower side of the washbasin by the retaining nut 9.

Subsequently, the valve block 4 is screwed onto the spring flange 11 by the two connecting screws 20. The valve block 4 itself is screwed to the mixing block 6 in a known manner.

Now, the spring flange 11 is slipped from below onto the diminution 28 of the water outlet housing 2. In so doing, the diminution 28 serves as a slip-on aid for the clamping spring 15, which is initially spread as it is slipped on.

Owing to its pretension, the clamping spring 15 on reaching the housing groove 10 penetrates, with approximately half its profile depth, into this groove. Further penetration is limited by the depth of the housing groove 10. The clamping spring 15 is now situated with its inner profile half in the housing groove 10 and with its outer profile half in the flange groove 12, so that the spring flange 11 is virtually fixed axially relative to the plug-in connecting piece 25. The spring flange 11 and the valve block 4 are prefixed on the plug-in connecting piece 25 so that the fitter has both hands free to screw the connecting screws 20 uniformly further into the respective threaded bores 19 in the spring flange 11.

As soon as the fixing pin 23 butts against the lower end side of the plug-in connecting piece 25, the spring flange 11 and the valve block 4 are rotated by the fitter relative to the water outlet housing 2 so that the fixing pin 23 is positioned opposite the fixing-pin receptacle 24.

On further tightening of the connecting screws 20, the fixing pin 23 penetrates into the fixing-pin receptacle 24, the spring flange 11 is braced and the lower end side of the plug-in connecting piece 25 is sealed off by the moulded seal 22 with respect to the upper end side of the valve block 4.

Owing to the pull on the spring flange 11, the clamping spring 15 is moved upwards relative to the spring flange 11, so that the two guide pins 16 are guided along the respective guide slopes 18 and moved towards one another.

Through the progressive self-locking, the spring flange 11 is prevented from being able to slip downwards from the water outlet housing 2.

Instead of the threaded bores 19 in the spring flange 11, it is also possible to provide bores without threads, which each have a thread spring imitating a thread. The thread springs are arranged so that they open in the push-in direction of the connecting screws 20, namely from the bottom upwards in FIGS. 1, 2, 3. In this way, the connecting screws 20 can be quickly inserted without being screwed, thereby enabling markedly quicker mounting. As soon as the thread springs are under tension, they contract and block the respective connecting screw 20, so that these screws can no longer be pulled downwards out of the bores in the spring flange 11. Subsequently, the connecting screws 20 are screwed in further to fix the connection.

The threaded bores 19 or the thread springs may also be arranged in the valve block 4 instead of in the flange 11.

It is also possible to provide only one or more than two connecting screws 20 with corresponding threaded bores 19 or thread springs.

The clamping spring 15 may also have a flat or angular profile, for example, instead of a round profile.

Instead of the guide slopes 18, it is also possible for guide slopes to run along the flange groove 12, for example. The upper wall of the flange groove 12 may be circumferentially bevelled, for example, so that the clamping spring 15 is pressed uniformly radially inwards as soon as the spring flange 11 is under tension. In this case, the guide pins 16 are not necessary.

1. A sanitary fitting comprising a connecting device which is used to connect a water outlet housing to a functional component, wherein
the connecting device has a clamping device (10, 11, 12, 15), by which the functional component can be temporarily fixed to the water outlet housing by a relative movement, and a tensioning device, by which the functional component can be stably connected to the water outlet housing.

2. The sanitary fitting of claim 1, wherein the clamping device comprises the following cooperating components:
a) at least one clamping spring,
b) a first groove, adapted to the clamping spring, in a first component, in particular a flange groove in a spring flange connected to the functional component,
c) a second groove, adapted to the clamping spring and facing the first groove, in a second component displaceable relative to the first component, in particular a housing groove in the water outlet housing.

3. The sanitary fitting of claim 2, wherein the tensioning device comprises at least one connecting screw and a corresponding thread, by which screw and thread the first component, in particular the spring flange, is tensibly connected to the functional component.

4. The sanitary fitting of claim 3, further comprising a thread spring for receiving the connecting screw.

5. The sanitary fitting of claim 1, wherein the clamping device has an in particular progressive self-locking device, in particular at least one guide slope for the clamping spring, in particular for at least one guide pin of the clamping spring.

6. The sanitary fitting of claim 1, wherein the connecting device has at least one fixing device for fixing the angular position of the functional component relative to the water outlet housing, in particular a fixing pin and a fixing-pin receptacle cooperating with the latter.

7. The sanitary fitting of claim 1, wherein the water outlet housing is sealed off with respect to the functional component by a moulded seal.

8. The sanitary fitting of claim 1, wherein the functional component comprises a valve block and/or a mixing block.

9. The sanitary fitting of claim 2, wherein the clamping device has an in particular progressive self-locking device, in particular at least one guide slope for the clamping spring, in particular for at least one guide pin of the clamping spring.

10. The sanitary fitting of claim 9, wherein the connecting device has at least one fixing device for fixing the angular position of the functional component relative to the water outlet housing, in particular a fixing pin and a fixing-pin receptacle cooperating with the latter.

11. The sanitary fitting of claim 10 wherein the water outlet housing is sealed off with respect to the functional component by a moulded seal.

12. The sanitary fitting of claim 11, wherein the functional component comprises a valve block and/or a mixing block.

13. The sanitary fitting of claim 3, wherein the clamping device has an in particular progressive self-locking device, in particular at least one guide slope for the clamping spring, in particular for at least one guide pin of the clamping spring.

14. The sanitary fitting of claim 13, wherein the connecting device has at least one fixing device for fixing the angular position of the functional component relative to the water outlet housing, in particular a fixing pin and a fixing-pin receptacle cooperating with the latter.

15. The sanitary fitting of claim 14 wherein the water outlet housing is sealed off with respect to the functional component by a moulded seal.

16. The sanitary fitting of claim 15, wherein the functional component comprises a valve block and/or a mixing block.

17. The sanitary fitting of claim 4, wherein the clamping device has an in particular progressive self-locking device, in particular at least one guide slope for the clamping spring, in particular for at least one guide pin of the clamping spring.

18. The sanitary fitting of claim 17, wherein the connecting device has at least one fixing device for fixing the angular position of the functional component relative to the water outlet housing, in particular a fixing pin and a fixing-pin receptacle cooperating with the latter.

19. The sanitary fitting of claim 18 wherein the water outlet housing is sealed off with respect to the functional component by a moulded seal.

20. The sanitary fitting of claim 19, wherein the functional component comprises a valve block and/or a mixing block.
